(19) United States
(12) Patent Application Publication
(10) Pub. No.: US 2006/0250672 A1
(43) Pub. Date: Nov. 9, 2006

(54) Agile mandrel apparatus and method

(76) Inventor: Mark A. Ealey, Littleton, MA (US)

Correspondence Address: Iandiorio & Teska, 260 Bear Hill Road, Waltham, MA, 02451-1018, US

(21) Appl. No.: 11/125,059

(22) Filed: May 6, 2005

(51) Int. Cl. G02B 26/08

(52) U.S. Cl. 359/196

(57) ABSTRACT

Agile mandrel apparatus and method for fabricating replicated optical components including a substrate having an optical surface with an optical finish and an initial optical figure and a plurality of actuators for deforming the optical surface to a predetermined final optical figure precursor of the optical component to be replicated.

### FIELD OF THE INVENTION

This invention relates to an agile mandrel apparatus and method for fabricating replicated optical components.

### BACKGROUND OF THE INVENTION

The cost of making an optical component such as a mirror is directly a function of the asphericity of the finished optical surface or final optical figure. The greater the curvature and asphericity, the greater the cost and time required. Flat mirrors and spherical mirrors are easy to grind and polish. But when the final optical figure is aspheric the tool must be small in order to faithfully reproduce the curved surface. The need for accuracy and the small tool involved makes the process time consuming and expensive and requires the use of a full five degree of freedom tool drive. These shortcomings apply whether grinding or shaping the ultimate optical component from a blank or making a mold or mandrel with which to make replicated optics.

### BRIEF SUMMARY OF THE INVENTION

It is therefore an object of this invention to provide an agile mandrel apparatus and method for fabricating replicated optical components.

It is a further object of this invention to provide an agile mandrel apparatus and method for fabricating replicated optical components of custom optical figures or shapes without the usual cost, time, and complexity.

It is a further object of this invention to provide an agile mandrel apparatus and method for fabricating replicated optical components of custom optical figures or shapes of highly curved, aspheric and other complex optical figures.

It is a further object of this invention to provide an agile mandrel apparatus and method for fabricating replicated optical components which is programmable to shapes simple and complex, spheric and aspheric.

It is a further object of this invention to provide an agile mandrel apparatus and method for fabricating replicated optical components which can assume optical figures globally, with mid and high order spatial resolution and even with Zernike level resolution.

It is a further object of this invention to provide an agile mandrel apparatus and method for fabricating replicated optical components which imparts a high quality optical finish to replicated optical components.

It is a further object of this invention to provide an agile mandrel system and method for fabricating a range of replicated optical components.

The invention results from the realization that one or a set of agile mandrels for fabrication of replicated optical components which can be programmed to assume a wide range of optical figures simple and complex, spheric and aspheric, to global, mid and high order and even Zernike level resolutions can be effected with a substrate having an optical surface with an optical finish and an initial optical figure and a plurality of actuators for deforming the optical surface to a predetermined final optical figure precursor of the optical component to be replicated.

The subject invention, however, in other embodiments, need not achieve all these objectives and the claims hereof should not be limited to structures or methods capable of achieving these objectives.

This invention features an agile mandrel for fabricating replicated optical components including a substrate having an optical surface with an optical finish and an initial optical figure; and a plurality of actuators for deforming the optical surface to a predetermined final optical figure precursor of the optical component to be replicated.

In a preferred embodiment the initial optical figure precursor may be an inverse of the final optical figure. The substrate may include an optical material from the group metals, glasses, ceramics, polymers and composites thereof. The substrate may include silicon carbide. The actuators may be generally parallel to the mounting surface or generally transverse to the mounting surface. The substrate may include a face sheet bearing the optical surface and the actuators may extend between the face sheet and a base member. The substrate may include the surface on one side and a support structure on the other and the actuators may be embedded in the support structure spaced from and generally parallel to the surface for applying bending moments to the surface for controllably altering the shape of the surface. The support structure may include an array of intersecting major ribs. The actuators may be mounted in the major ribs between the intersections. The support structure may include cathedral ribs on the back side of the surface. The ribs may contain a recess for receiving the actuators. The actuators may include electrostrictive devices. The actuators may include lead magnesium niobate electrostrictive devices. The support structure may include an array of spaced posts. The actuators may extend between pairs of the spaced posts. There may be a wavefront sensor for sensing wavefront error and a control system responsive to the wavefront errors to drive the actuators to reduce the wavefront errors.

The invention also features an agile mandrel system for fabricating a range of replicated optical components including a set of substrates each having an optical surface with an optical finish and an initial optical figure and a plurality of sets of actuators for deforming each of the optical surfaces within a range around its initial optical figure to a predetermined final optical figure precursor of an optical component to be replicated.

In a preferred embodiment the initial optical figures may be spherical or may be parabolic.

This invention also features a method of fabricating replicated optical components including providing an agile mandrel having a substrate having an optical surface with an optical finish and an initial optical figure and a plurality of actuators for deforming the optical surface and deforming the optical surface to a predetermined final optical figure precursor of the optical component to be replicated.

In a preferred embodiment the invention includes the initial optical figure precursor may be an inverse of the final optical figure. The substrate may include an optical material from the group metals, glasses, ceramics, polymers and composites thereof. The substrate may include silicon carbide. The actuators may be generally parallel to the mounting surface.

The invention also features a method of fabricating a range of replicated optical components including providing a set of agile mandrels including a set of substrates each having an optical surface with an optical finish and an initial optical figure and a plurality of sets of actuators for deforming each of the optical surfaces within a range around its initial optical figure to a predetermined final optical figure precursor of an optical component to be replicated.

In a preferred embodiment the initial optical figures may be spherical or may be parabolic.

### BRIEF DESCRIPTION OF THE DRAWINGS

Other objects, features and advantages will occur to those skilled in the art from the following description of a preferred embodiment and the accompanying drawings, in which:

FIG. 1 is a three dimensional diagrammatic view an agile mandrel according to this invention;

FIG. 2 is a three dimensional view of the other side of the agile mandrel of FIG. 1 showing the support structure;

FIG. 3 is an enlarged three dimensional view of a portion of the support structure of FIG. 2 with actuators installed;

FIG. 4 is an enlarged three dimensional view of an actuator and actuator mounting;

FIG. 5 is an enlarged three dimensional view of another actuator and actuator mounting implementation;

FIGS. 6 and 7 are graphs illustrating the factors effecting excursion and correctability, respectively;

FIG. 8 is a three dimensional view of another support structure usable with this invention;

FIG. 9 is a diagram showing the method embodied in software in a microprocessor for driving the actuator to manipulate the shape of the agile mandrel;

FIG. 10 is a schematic side sectional view of an agile mandrel according to this invention employing transverse actuators;

FIG. 11 is a schematic side sectional view of an agile mandrel according to this invention employing edge actuators;

FIG. 12 is a schematic side sectional view of the agile mandrel of this invention with its replicating surface in an initial figure or shape;

FIG. 13 is a schematic side sectional view of the agile mandrel of this invention with its replicating surface in the final figure or shape after operation of the actuators; and

FIG. 14 is a schematic, sectional view of an agile mandrel system for fabricating a range of replicated optical components according to this invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

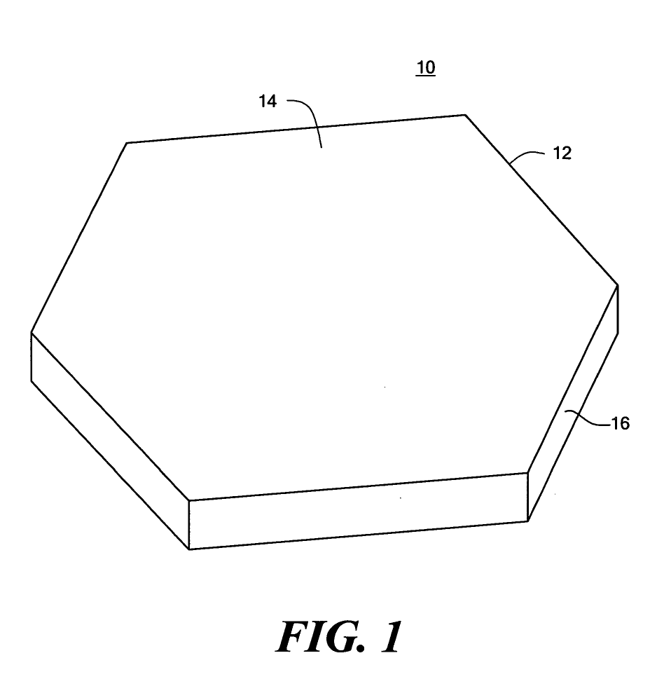

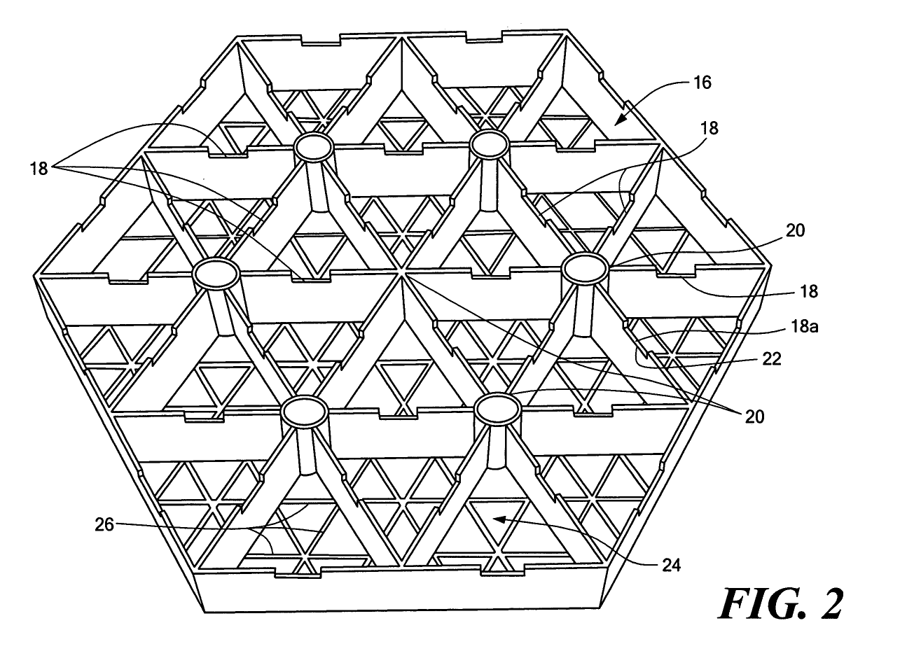

This invention features an agile mandrel 10, FIG. 1, including a substrate 12, typically silicon carbide or an equivalent, such as metal, glass, ceramic, polymer and components thereof including but not limited to a Fused Silica, ULE, Zerodur, Al 6061-T6, MMC 30% SiC, Be I-70. Be I-220-H, Cu OFC, Cu Glidcop, Invar 36, Super Invar, beryllium, Molybdenum, Silicon, SiC HP alpha, SiC CVD beta SoC RB 30% Si, C/SiC, SS 304, SS 416, SS 17-4PH, Ti 6A14V, Gr/EP GY70×30, having a high quality optical surface 14 on one side and support structure 16, FIG. 2, on the other side. Support structure 16 may include a plurality of major ribs 18, which intersect at a node 20 at the center of a zone of influence. Each major rib, such as rib 18a, includes recess or notch 22 in which an actuator may be located. The array of major ribs creates a honeycomb-like structure supporting back side 24 of the surface 14 on which can be located cathedral ribs 26 for strengthening and further supporting surface 14.

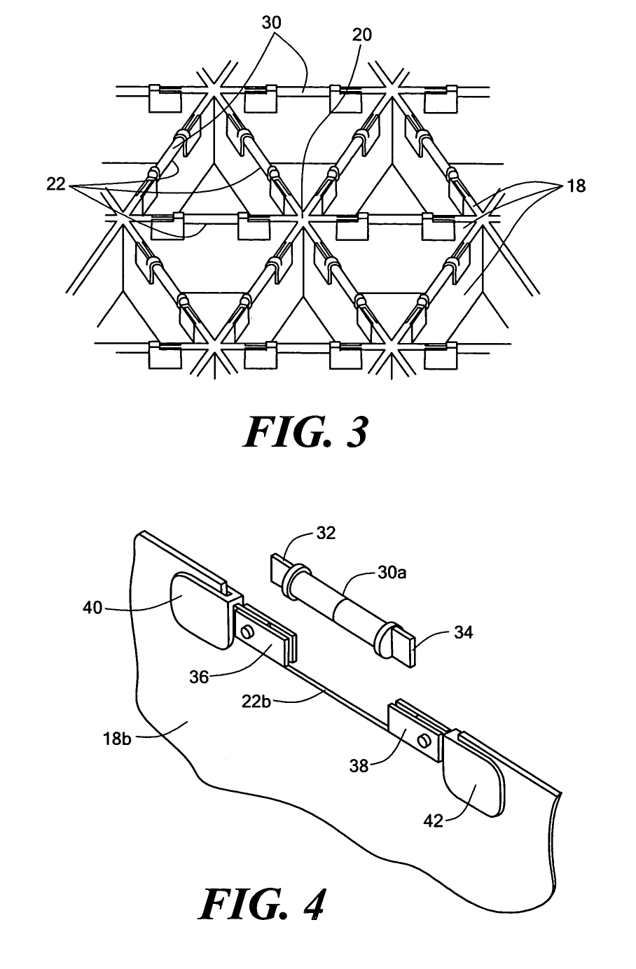

Actuators 30, FIG. 3, are embedded in recesses 22 of ribs 18 generally parallel to the surface 14 and spaced from it. When operated either by extension or contraction, actuators 30 apply bending moments to alter the shape of the surface 14, both locally for correctability, and globally to effect radius of curvature alterations. Because actuators 30 act directly on the support structure in which they are embedded, they require no reaction mass. In addition, even though they may be displacement devices, they can perform a very effective radius of curvature or excursion shape alteration because their effect is cumulative.

Each of the actuators 30 may be an electrostrictive device or a magnetostrictive device, a piezoelectric device or any other suitable type of actuator such as hydraulic, voice coil, solenoid, mechanical or phase change material such as shape memory alloys or paraffin. In this preferred embodiment, they are illustrated as electrostrictive devices of the lead-magnesium niobate or PMN type which are preferred because they have a low thermal coefficient and very little hysteresis and creep and are dimensionally stable to sub-Angstrom levels. The actuators are characteristically easy to install and replace. For example, actuator 30a, FIG. 4, may contain mounting tabs 32 and 34 which are receivable in mounting clips 36 and 38 mounted in notch 22b of rib 18b. Slots 36 and 38 may be mounted to rib 18b by means of clamps 40 and 42. All of the interfaces may be supplied with an adhesive to permanently bond actuator 30a in position. The actuators may be ambient temperature actuators or cryogenic actuators so that the agile mandrel can be converted from one type of operation to another quite easily by simply removing one type and replacing it with the other.

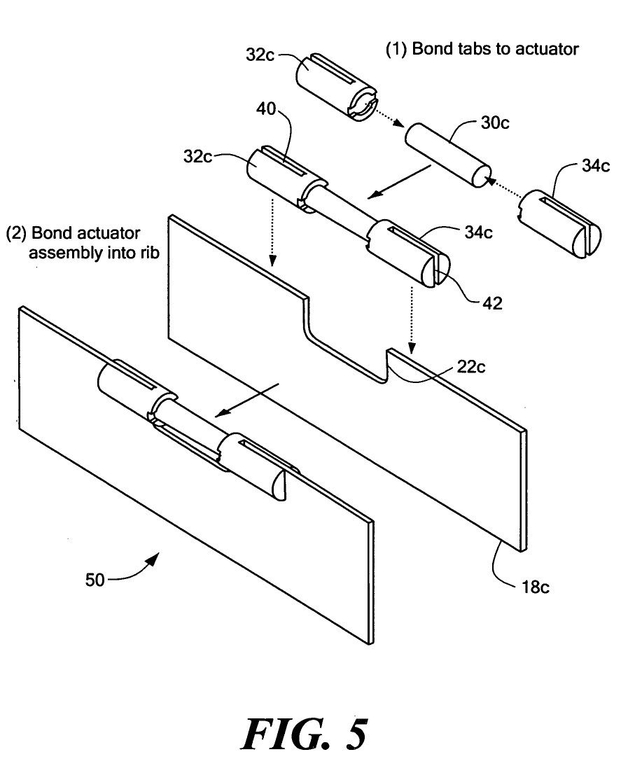

Another type of actuator mounting is shown in FIG. 5 where a three step installation is shown beginning with the actuator 30c being supplied with bonding tabs 32c and 34c which may be glued to it. This assembly is then installed in recess 22c of major rib 18c by engaging the slots 40 and 42 in tabs 32c and 34c with the edges of recess 22c so that the final assembly appears as at 50 in FIG. 5. Again, some or all of the engagements may have an adhesive applied to bond the components.

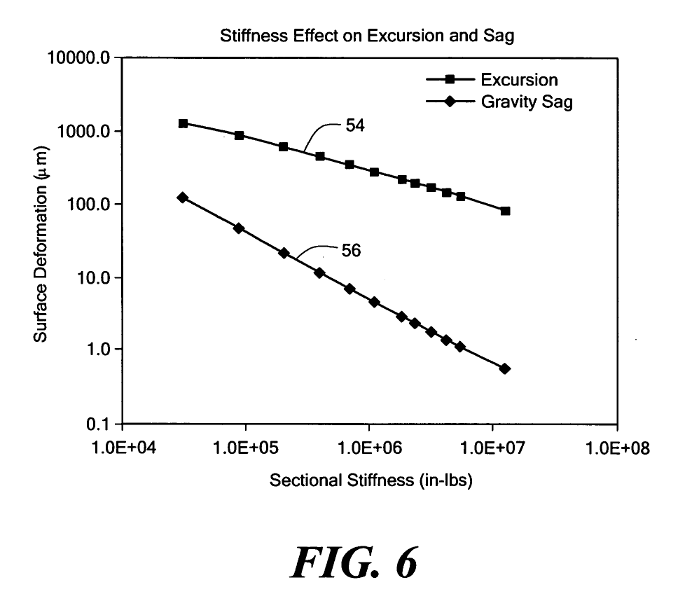

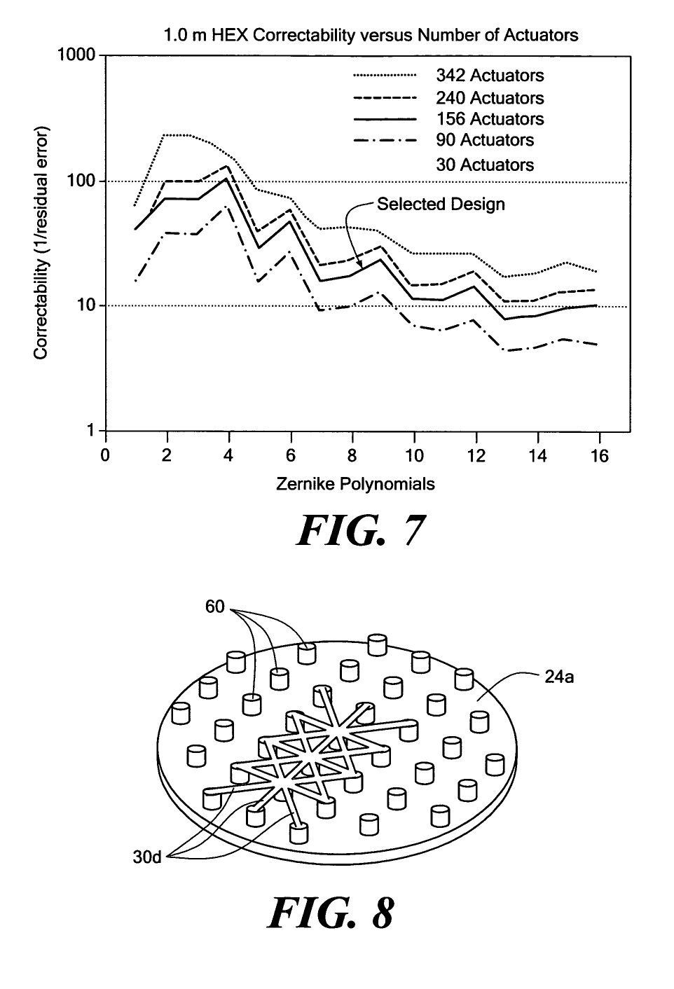

The advantages of this construction are illustrated in FIGS. 6 and 7. FIG. 6 illustrates the trade-offs with respect to excursion where the surface deformation associated with excursion and gravity sag are both in satisfactory ranges expressed in sectional stiffness in inch pounds. The trade-off with respect to correctability is demonstrated in FIG. 7 where the correctability is plotted against Zernike polynomials indicating that the localized correction or correctability performs quite well even at high Zernike polynomials with adequate numbers of actuators. And adequate numbers of actuators is not a problem as they are small, lightweight, and can be highly densely packed.

Although the support structure shown is a honeycomb-like structure formed from the intersecting ribs, this is not a necessary limitation of the invention. For example, in FIG. 8 the support structure on back surface 24a constitutes spaced bumps or dimples or posts 60 and the actuators 30d are connected between pairs of posts effecting the bending moments and creating the nodes as previously explained with respect to the honeycomb structure.

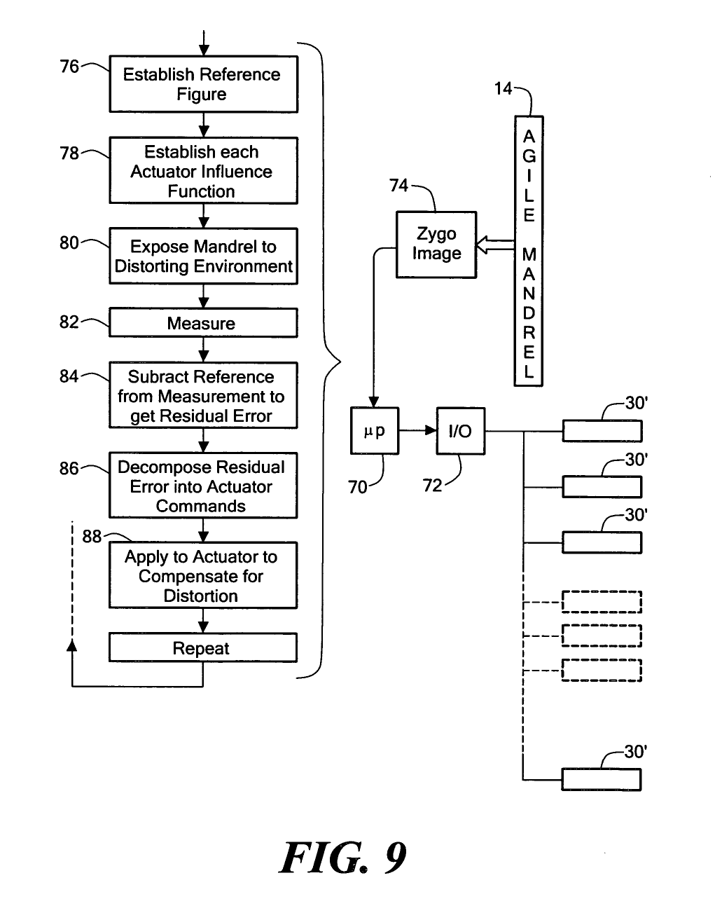

Any suitable hardware or software system may be used to monitor and feedback control signals to the agile mandrel according to this invention. One such system is illustrated in FIG. 9 by way of example and not limitation. There microprocessor 70 drives I/O device 72 to provide voltages to actuators 30′. The zygo image 74 is generated from surface 14, FIG. 1. Microprocessor 70 is configured with software to establish a reference FIG. 76 and then establish for each actuator an influence function on its associated nodes or zones 78. Surface 14 is then exposed to a distorting environment 80 and once again measured in step 82. The reference is then subtracted from the measurement to get residual error 84 and the residual error is decomposed 86 into actuator commands which are then applied 88 to the actuators through I/0 device 72 to provide the proper voltages to actuators 30′. This routine is carried out repeatedly in order to keep surface 14 at the optimum shape. Although the preferred embodiment discussed above is generally of the zonal type, the agile mandrel of this invention may be implemented as a modal type or any other type.

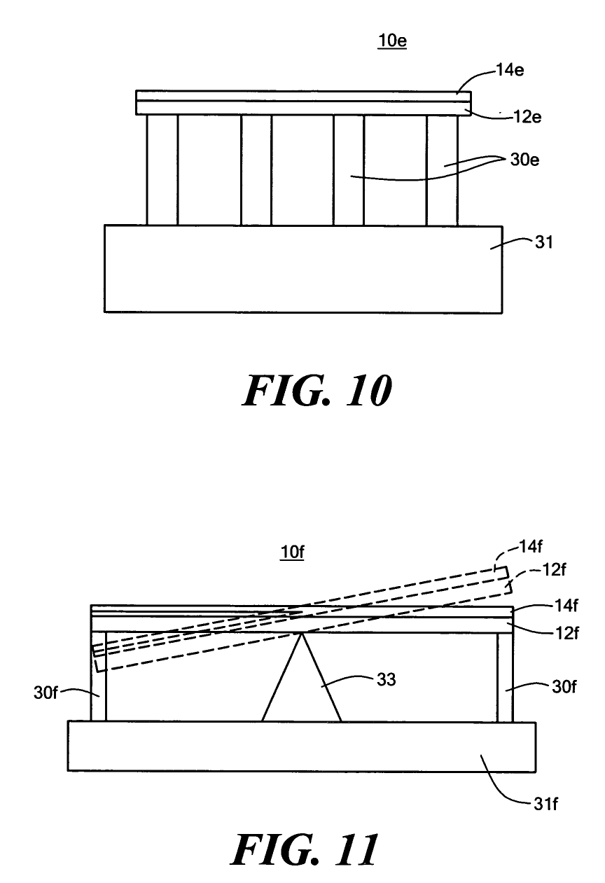

While thus far the actuator mechanism has been shown as using parallel oriented actuators embedded in the support structure, this is not a limitation of the invention. Agile mandrel 10e, FIG. 10, may include an optical surface e.g. 14e on face sheet 12e deformable by transverse actuators 30e mounted on base 31. Alternatively, FIG. 11, face sheet 12f with optical surface 14f can be edge driven by actuators 30f about a central support 33.

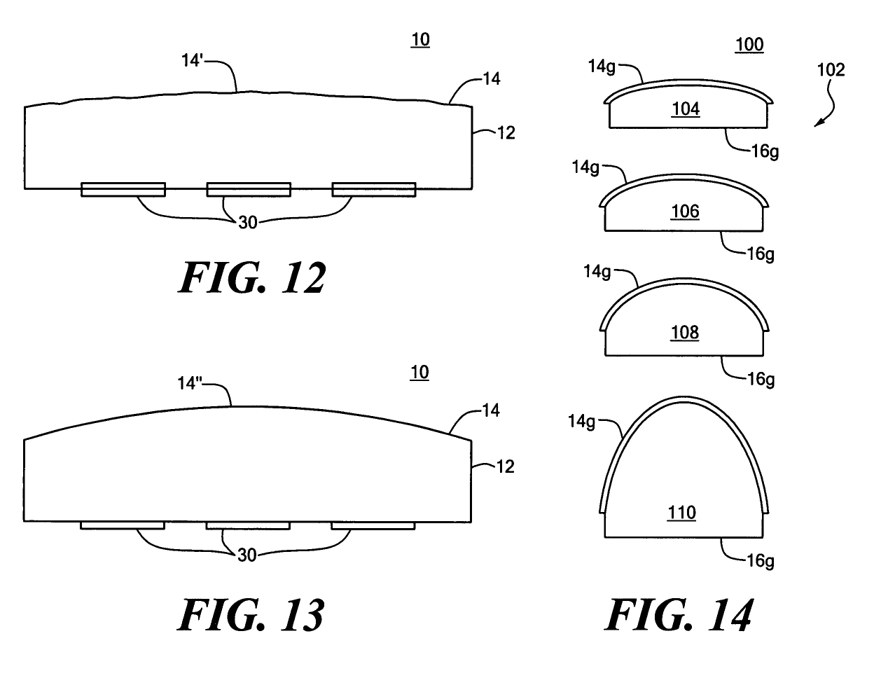

In operation, agile mandrel 10, FIG. 12, is shaped to an initial optical shape or figure precursor while surface 14 may be still somewhat inexact as illustratively indicated at 14′. After operation of actuators 30, FIG. 13, surface 14 approaches its final optical shape or figure precursor as at 14″. This final figure precursor may be the inverse of the optical component to be replicated. Typically, practically, but not necessarily, the initial shape is also generally the inverse of the predetermined final shape. Thus, this invention eases the need for mandrel grinding and polishing and enables the same mandrel to accommodate a number of different shapes spheric and aspheric, simple and complex, quickly and easily to facilitate rapid replication of many different high optical quality.

In a typical manufacturing operation there may be a system of agile mandrels 100, FIG. 14, for making a range of replicated optical components. There is a set 102 of agile mandrels 104-110, each one with a different initial optical figure, with a shape that is easier to facilitate, e.g. spherical, parabolic, but which can be actuated to effect global and/or local deformation to arrive at any desired final optical figure. Support structures 16g may include all the components 18, 20, 22, 24, 26, 30 etc. as shown, supra, in FIGS. 1-5.

Any suitable actuators may be used in this invention, examples of which are disclosed in U.S. patent application Ser. No. 10/730,514, filed Dec. 8, 2003, entitled, Transverse Electrodisplacive Actuator Array, by Mark A. Ealey, and U.S. patent application Ser. No. 10/914,450, filed on Aug. 9, 2004, entitled, Improved Multi-Axis Transducer, by Mark A. Ealey, each of which is herein incorporated in its entirety by this reference. See also U.S. patent application Ser. No. 10/730,412, filed Dec. 8, 2003, entitled Integrated Zonal Meniscus Mirror, by Mark A. Ealey, which employs an active substrate such as used herein in an integrated zonal meniscus mirror and which is herein incorporated in its entirety by this reference. The agile mandrel is useful in making optical surfaces such as nanolaminates as disclosed in Lawrence Livermore National Laboratory, see Nano-Laminates: A New Class of Materials for Aerospace Applications by Troy W. Barbee, Jr., Lawrence Livermore National Laboratory, Livermore, Calif. 94550-9234, U.S. patent application Ser. No. 11/039,132 filed on Jan. 19, 2005, entitled. Active Hybrid Optical Component by Mark A. Ealey, and U.S. patent application entitled Method Of Fabricating Replicated Optics filed on even date herewith by Ealey et al. each of which is herein incorporated in its entirety by this reference.

The method of fabricating replicated optics according to this invention involves providing one or a set of substrates having on an optical surface with an optical finish and an initial optical figure and a plurality of actuators for deforming the optical surface, and deforming that optical surface to a predetermined optical figure precursor of the optical component to be replicated.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. An agile mandrel for fabricating replicated optical components comprising:
a substrate having an optical surface with an optical finish and an initial optical figure; and
a plurality of actuators for deforming said optical surface to a predetermined final optical figure precursor of the optical component to be replicated.

2. The agile mandrel for fabricating replicated optical components of claim 1 in which said initial optical figure precursor is an inverse of said final optical figure.

3. The agile mandrel for fabricating replicated optical components of claim 1 in which said substrate includes an optical material from the group metals, glasses, ceramics, polymers and composites thereof.

4. The agile mandrel for fabricating replicated optical components of claim 1 in which said substrate includes silicon carbide.

5. The agile mandrel for fabricating replicated optical components of claim 1 in which said actuators are generally parallel to said mounting surface.

6. The agile mandrel for fabricating replicated optical components of claim 1 in which said actuators are generally transverse to said mounting surface.

7. The agile mandrel for fabricating replicated optical components of claim 6 in which said substrate includes a face sheet bearing said optical surface and said actuators extend between said face sheet and a base member.

8. The agile mandrel for fabricating replicated optical components of claim 5 in which said substrate includes said surface on one side and a support structure on the other and said actuators are embedded in said support structure spaced from and generally parallel to said surface for applying bending moments to said surface for controllably altering the shape of said surface.

9. The agile mandrel for fabricating replicated optical components of claim 8 in which said support structure includes an array of intersecting major ribs.

10. The agile mandrel for fabricating replicated optical components of claim 8 in which said actuators are mounted in said major ribs between said intersections.

11. The agile mandrel for fabricating replicated optical components of claim 8 in which said support structure includes cathedral ribs on the back side of said surface.

12. The agile mandrel for fabricating replicated optical components of claim 8 in which said ribs contain a recess for receiving said actuators.

13. The agile mandrel for fabricating replicated optical components of claim 1 in which said actuators include electrostrictive devices.

14. The agile mandrel for fabricating replicated optical components of claim 1 in which said actuators include lead magnesium niobate electrostrictive devices.

15. The agile mandrel for fabricating replicated optical components of claim 8 in which said support structure includes an array of spaced posts.

16. The agile mandrel for fabricating replicated optical components of claim 15 in which said actuators extend between pairs of said spaced posts.

17. The agile mandrel for fabricating replicated optical components of claim 1 further including a wavefront sensor for sensing wavefront error.

18. The agile mandrel for fabricating replicated optical components of claim 17 further including a control system responsive to the wavefront errors to drive the actuators to reduce the wavefront error.

19. An agile mandrel system for fabricating a range of replicated optical components comprising:
a set of substrates each having an optical surface with an optical finish and an initial optical figure; and
a plurality of sets of actuators for deforming each of said optical surfaces within a range around its initial optical figure to a predetermined final optical figure precursor of an optical component to be replicated.

20. The agile mandrel system for fabricating a range of replicated optical components of claim 19 in which said initial optical figures are spherical.

21. The agile mandrel system for fabricating a range of replicated optical components of claim 19 in which said initial optical figures are parabolic.

22. A method of fabricating replicated optical components comprising:
providing an agile mandrel including a substrate having an optical surface with an optical finish and an initial optical figure and a plurality of actuators for deforming the optical surface; and
deforming the optical surface to a predetermined final optical figure precursor of the optical component to be replicated.

23. The method of fabricating replicated optical components of claim 22 in which said initial optical figure precursor is an inverse of said final optical figure.

24. The method of fabricating replicated optical components of claim 22 in which said substrate includes an optical material from the group metals, glasses, ceramics, polymers and composites thereof.

25. The method of fabricating replicated optical components of claim 22 in which said substrate includes silicon carbide.

26. The method of fabricating replicated optical components of claim 22 in which said actuators are generally parallel to said mounting surface.

27. A method of fabricating a range of replicated optical components comprising:
providing a set of agile mandrels including a set of substrates each having an optical surface with an optical finish and an initial optical figure; and
a plurality of sets of actuators for deforming each of said optical surfaces within a range around its initial optical figure to a predetermined final optical figure precursor of an optical component to be replicated.

28. The method of fabricating a range of replicated optical components of claim 27 in which said initial optical figures are spherical.

29. The method of fabricating a range of replicated optical components of claim 27 in which said initial optical figures are parabolic.
